(19) United States
(12) Patent Application Publication
(10) Pub. No.: US 2017/0334480 A1
(43) Pub. Date: Nov. 23, 2017

(54) ELECTRIC POWER STEERING DEVICE

(71) Applicant: TOYOTA JIDOSHA KABUSHIKI KAISHA, Toyota-shi (JP)

(72) Inventor: Ippei YAMAZAKI, Toyota-shi (JP)

(73) Assignee: TOYOTA JIDOSHA KABUSHIKI KAISHA, Toyota-shi (JP)

(21) Appl. No.: 15/497,377

(22) Filed: Apr. 26, 2017

(30) Foreign Application Priority Data
May 17, 2016 (JP) 2016-098396

(51) Int. Cl. B62D 5/04; B62D 3/12; B62D 15/02

(52) U.S. Cl. CPC B62D 5/0463; B62D 15/0215; B62D 3/12; B62D 5/0409

(57) ABSTRACT

In an electric power steering device which controls an assist motor such that a turning angle of turning wheels approaches a target turning angle set corresponding to steering torque based on an operation of a steering wheel by a driver, pure steering torque is calculated by correcting detection steering torque detected by a torque sensor based on a steering angle detected by a steering angle sensor, and a target turning angle is set based on this pure steering torque. Thereby, influence of moment of inertia and viscous friction of a constituent member on an upstream side of the torque sensor in a steering mechanism, etc. is eliminated, and a correct target turning angle is set. As a result, the turning angle can accurately correspond to the operation of the steering wheel by the driver to attain good drivability.

### TECHNICAL FIELD

The present invention relates to an electric power steering device.

### BACKGROUND ART

In the art, an electric power steering device, in which assist torque that is torque transmitted to a steering mechanism from an assist motor such that a turning angle of turning wheels approaches a target turning angle set corresponding to steering torque based on an operation of a steering wheel by a driver, has been known (refer to the Patent Document 1 (PTL1).). This target turning angle is increased or decreased according to steering torque that is torque given to the steering wheel by the driver. Thereby, the steering torque given to a steering wheel by the driver can be reduced, while making the turning angle of the turning wheels correspond to the steering torque given by the driver.

By the way, the above mentioned steering torque is detected by a torque sensor based on a twist (wrench) of a torsion bar prepared in an intermediate shaft, etc., for example. Therefore, a detection value by the torque sensor may be affected by influence of moment of inertia and viscous friction of a constituent member on an upstream side (steering wheel side) of the torque sensor in a steering mechanism (hereinafter, which may be referred to as an “upstream side member”) (for example, a steering wheel, etc.).

Specifically, for example, a case where a constituent member on a downstream side (turning wheel side) of the torque sensor in the steering mechanism (hereinafter, which may be referred to as a “downstream side member”) rotates as a result of turning of a vehicle following the target turning angle in a state that the driver is not touching the steering wheel (steering torque=0 (zero)) is assumed. In this case, there is a possibility that steering torque may be detected by the torque sensor even though steering torque is 0 (zero), since the upstream side member cannot follow a rotation of the downstream side member instantly and a twist of the torsion bar occurs, due to the moment of inertia and viscous friction of the upstream side member, etc., for example.

Alternatively, a case where the driver takes his/her hand off the steering wheel in a state that the driver gives predetermined steering torque to a steering wheel to maintain a fixed steering angle (fixed steering) (steering torque=0 (zero)) is assumed. Also in this case, there is a possibility that steering torque may be detected by the torque sensor even though steering torque is 0 (zero), since the upstream side member cannot follow the rotation of the downstream side member instantly and a twist of the torsion bar occurs, due to the moment and viscous friction of inertia of the upstream side member, etc.

As mentioned above, the steering torque detected by the torque sensor may not correspond with the steering torque actually given to the steering wheel (hereinafter, which may be referred to as “pure steering torque”) under the influence of the moment of inertia and viscous friction of the upstream side member, etc. Therefore, when the target turning angle is increased or decreased according to the steering torque detected by the torque sensor, there is a possibility that it may become difficult to set a correct target steering angle. As a result, there is a possibility that it may become difficult to make the turning angle of the turning wheels correspond to the steering torque by the driver to attain good drivability.

### CITATION LIST

### Patent Literature

[PTL1] Japanese Patent Application Laid-Open (kokai) No. 2015-217793

### SUMMARY OF INVENTION

### Technical Problem

The present invention has been conceived in order to solve the above-mentioned problem. Namely, one of objectives of the present invention is to provide an electric power steering device which controls an assist motor such that a turning angle of turning wheels approaches a target turning angle set corresponding to steering torque based on an operation of a steering wheel by a driver and can make the turning angle accurately correspond to the operation of the steering wheel by the driver to attain good drivability.

### Solution to Problem

In view of the above, an electric power steering device according to the present invention (hereinafter, which may be referred to as the “present invention device”) comprises a steering mechanism (40), a torque sensor (21), a turning angle sensor (31), a target turning angle set part (51), a target assist torque set part (52) and a drive control part (53).

The above-mentioned steering mechanism is configured to change a turning angle (8c) of turning wheels (44L and 44R) by transmitting steering torque (Th) based on an operation of a steering wheel (20) by a driver and assist torque (Ta) that is torque generated by an assist motor (30) to a rack shaft (41). The above-mentioned torque sensor is configured to detect detection steering torque (Ts) that is a detection value corresponding to the steering torque. The above-mentioned turning angle sensor configured to detect the turning angle of the turning wheels.

The above-mentioned target turning angle set part is configured to set a target turning angle (θgt) that is a target value of the turning angle of the turning wheels. The above-mentioned target assist torque set part is configured to set target assist torque (Ta*) for bringing the turning angle close to the target turning angle. The above-mentioned drive control part is configured to control the assist motor based on an assist command value (Itgt) corresponding to the target assist torque set as mentioned above and bring the assist torque (Ta) close to the target assist torque set as mentioned above.

The present invention device further comprises a steering angle sensor (21s) and a pure steering torque calculation part (54).

The above-mentioned steering angle sensor is configured to detect a steering angle (θh) that is a rotation angle of the steering wheel. The above-mentioned pure steering torque calculation part is configured to calculate pure steering torque (Th) only based on an operation of the steering wheel by the driver by correcting the detection steering torque based on the steering angle.

In addition, in the present invention device, the above-mentioned target turning angle set part is configured to set the target turning angle based on orientation and magnitude of the pure steering torque.

### Advantageous Effects of Invention

In accordance with the present invention, in an electric power steering device which controls an assist motor such that a turning angle of turning wheels approaches a target turning angle set corresponding to steering torque based on an operation of a steering wheel by a driver, a target turning angle is set based on pure steering torque which is calculated only based on the operation of the steering wheel by the driver. Thereby, influence of moment of inertia (Ih) and viscous friction (Ch) of an upstream side member (for example, a steering wheel etc.) in a steering mechanism, etc. can be eliminated. As a result, the turning angle of the turning wheels can correspond to the steering torque by the driver to attain good drivability.

In the above-mentioned explanation, in order to help understanding of the present invention, to the configurations of the invention corresponding to the embodiments, which will be mentioned later, titles and/or signs used in the embodiments are attached in parenthesis. However, the constituent elements of the present invention are not limited to the embodiments specified with these titles and/or signs. Other objectives, other features and accompanying advantages of the present invention will be easily understood from the following explanation about the embodiments of the present invention described referring to the drawings.

### BRIEF DESCRIPTION OF DRAWINGS

FIG. 1 is a schematic view for showing a configuration of an electric power steering device according to a first embodiment of the present invention (first device).

FIG. 2 is a schematic block diagram for explaining functions of respective parts attained by a control part which the first device comprises.

FIG. 3 is a flowchart for showing a steering assist control routine performed by the first device.

FIG. 4 is a schematic view for explaining a relation between detection steering torque Ts detected by a torque sensor and pure steering torque Th only based on an operation of a steering wheel by a driver.

### DESCRIPTION OF EMBODIMENTS

### First Embodiment

Hereafter, an electric power steering device according to a first embodiment of the present invention (hereinafter, which may be referred to as a “first device”) will be explained referring to the drawings.

### <Configuration>

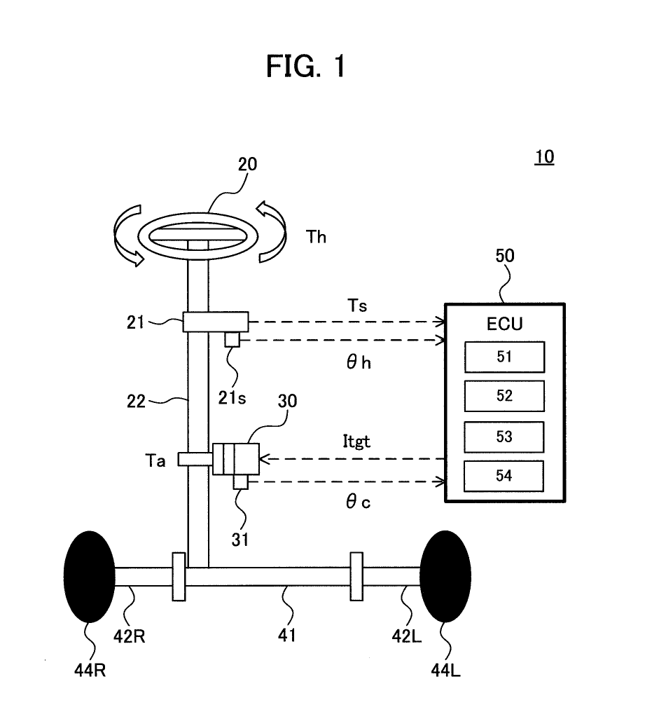

FIG. 1 is a schematic view for showing a configuration of the first device. The first device 10 comprises a steering mechanism 40 (to which no number is assigned in FIG. 1), a torque sensor 21, a turning angle sensor 31 and a control part 50.

The steering mechanism 40 is configured to change a turning angle of turning wheels 44L and 44R by transmitting steering torque Th (inputted to the steering mechanism 40 by an operation of a steering wheel) based on an operation of a steering wheel 20 by a driver and assist torque Ta that is torque generated by an assist motor 30 to the turning wheels 44L and 44R through a rack shaft 41. As shown in FIG. 1, the steering mechanism 40 is constituted by an intermediate shaft 22, a pinion gear (not shown), the rack shaft 41, tie rods 42L and 42R, etc. Namely, a column assist type rack and pinion system is adopted for the steering mechanism 40.

However, rack and pinion systems other than a column assist type, such as a pinion assist type and a rack assist type, may be adopted as the steering mechanism 40, for example. Namely, a configuration of the steering mechanism 40 is not particularly limited as long as it is possible to transmit the steering torque Th and the assist torque Ta to change the steering angle of the turning wheels 44L and 44R.

The torque sensor 21 is configured to detect detection steering torque Ts that is a detection value corresponding to the steering torque. Specifically, the torque sensor 21 detects the detection steering torque Ts by detecting twist of a torsion bar prepared in the intermediate shaft 22. A configuration of the torque sensor 21 is not particularly limited as long as it is possible to detect the detection steering torque Ts.

The turning angle sensor 31 is configured to detect the turning angle θc of the turning wheels. Specifically, the turning angle sensor 31 detects the turning angle θc based on an integrated value of a rotation angle of the assist motor 30. However, a configuration of the turning angle sensor 31 is not particularly limited as long as it is possible to detect the turning angle θc.

The control part 50 is an electronic control circuit (ECU: Electronic Control Unit) which has a microcomputer including a CPU (Central Processing Unit), a ROM (Read Only Memory), a RAM (Random Access Memory) and an interface, etc., as a main component. The control part 50 comprises a target turning angle set part 51, a target assist torque set part 52 and a drive control part 53, as functions of the ECU, respectively.

The target turning angle set part 51 is configured to set a target turning angle θtgt that is a target value of the turning angle θc of the turning wheels 44L and 44R. The target assist torque set part 52 is configured to set target assist torque Ta* for bringing the turning angle θc detected by the turning angle sensor 31 close to the target turning angle θtgt. The drive control part 53 is configured to control the assist motor 30 based on an assist command value Itgt corresponding to the target assist torque Ta* and bring the assist torque Ta close to the target assist torque Ta*. Such computing and control are attained by the CPU performing instructions (routine) stored in the memory (ROM).

However, as mentioned above, the detection steering torque Ts detected by the torque sensor 21 may be affected by the influence of the moment of inertia and viscous friction of the constituent member on the upstream side of the torque sensor 21 in the steering mechanism 40, etc. (upstream side member) (for example, the steering wheel 20, etc.). Therefore, when the target turning angle θtgt is set according to the detection steering torque Ts, the target turning angle θtgt may also be affected by the influence of the moment of inertia and viscous friction of the steering wheel 20, etc. As a result, there is a possibility that it may become difficult to make the turning angle θc of the turning wheels 44L and 44R correspond to true steering torque (pure steering torque Th) by the driver to attain good drivability.

Then, the first device 10 further comprises a steering angle sensor 21s and a pure steering torque calculation part 54. The steering angle sensor 21 is configured to detect a steering angle θh that is a rotation angle of the steering wheel 20.

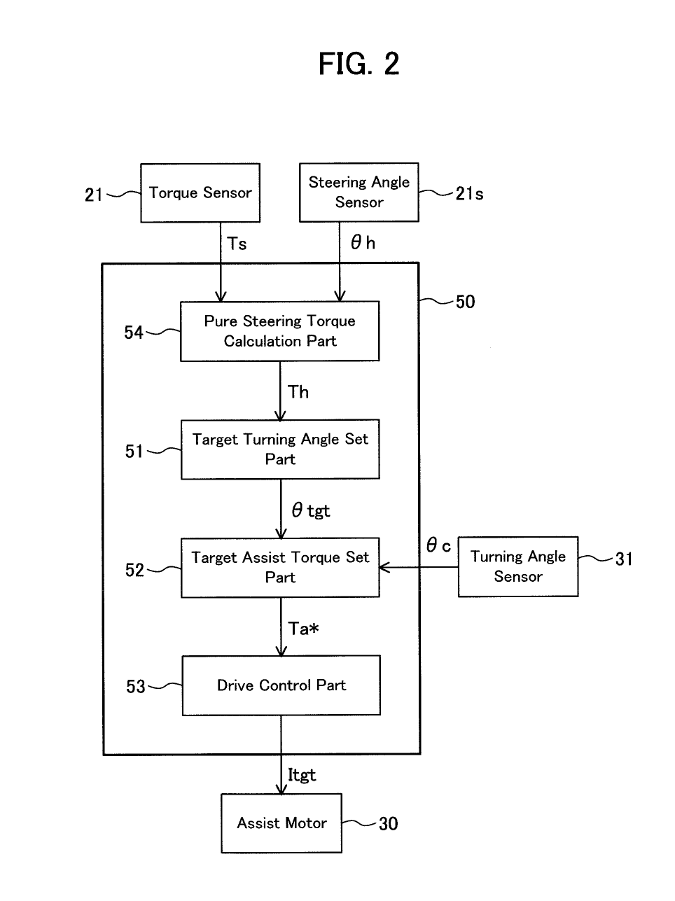

As shown in FIG. 2, the pure steering torque calculation part 54 is configured to calculate pure steering torque Th only based on an operation of the steering wheel 20 by the driver by correcting the detection steering torque Ts based on the steering angle θh. In addition, the target turning angle set part 51 is configured to set the target turning angle θtgt based on orientation and magnitude of the pure steering torque Th.

As a result of the above, the target assist torque set part 52 can set correct target assist torque Ta* based on a correct target turning angle θtgt corresponding to the steering torque by the driver, and the drive control part 53 can correctly control the assist motor 30 based on the assist command value Itgt corresponding to the correct target assist torque Ta*.

### <Operation>

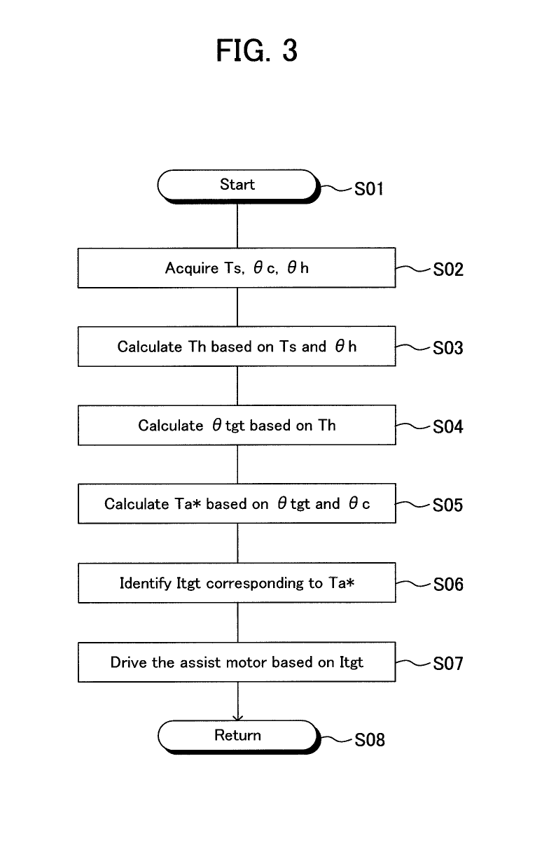

Next, an operation of the first device 10 will be explained in detail. The CPU which the ECU constituting the control part 50 comprises (hereinafter, which may be simply referred to as the “CPU”) performs a “steering assist control routine” shown in FIG. 3 as a flowchart, whenever a predetermined time period (operation period) Δt passes.

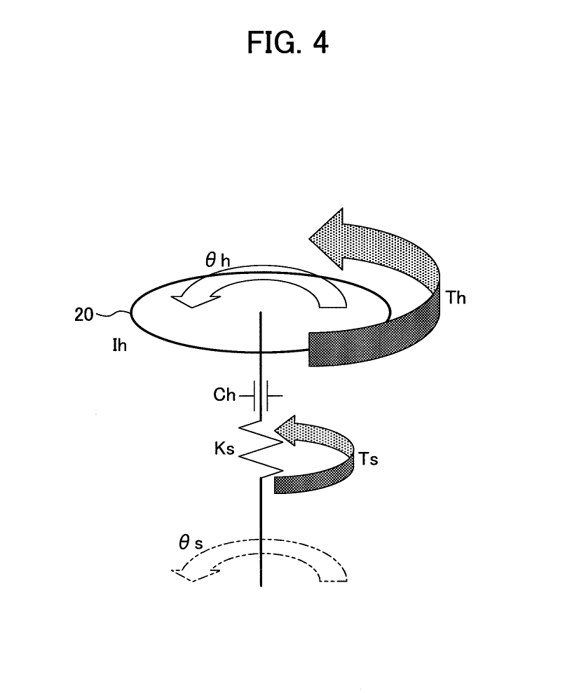

After the routine is started in step S01, the CPU progresses to step S02, and acquires the detection steering torque Ts, the turning angle θc of the steered wheels 44L and 44R and the steering angle θh that is a rotation angle of the steering wheel 20 from the torque sensor 21, the turning angle sensor 31 and the steering angle sensor 21s, respectively. The detection steering torque Ts is a torque detected by the torque sensor 21 based on twist of the torsion bar. Therefore, as shown in FIG. 4, the detection steering torque Ts can be expressed as the following Formula (1), in which θs is a rotation angle of the downstream side member of the torque sensor 21 and Ks is a proportional constant corresponding to rigidity of the torsion bar.

Ts=Ks(θh−θs) (1)

As apparent from Formula (1), the detection steering torque Ts is a torque detected due to difference between the rotation angle (θh) of the upstream side member and the rotation angle (θs) of a downstream side member of the torque sensor 21. The difference between these rotation angles results from the influence of the moment of inertia and viscous friction of the constituent member on the upstream side of the torque sensor 21 in the steering mechanism 40 (upstream side member) (for example, the steering wheel 20, etc.), etc. A motion equation of the system shown in FIG. 4 can be expressed by the following Formula (2), in which Ih is the moment of inertia of the steering wheel 20 and Ch is the viscous friction of the upstream side member.

$$Th - Ts = Ih ( \frac{{d}^{ 2} θ h}{{dt}^{ 2}} ) + Ch ( \frac{d θ h}{dt} ) \qquad ( 2 )$$

Then, the CPU progresses to step S03, and calculates the pure steering torque Th according to the Following Formula (3) derived from Formula (2). Namely, the CPU functions as the pure steering torque calculation part 54, corrects the detection steering torque Ts based on the steering angle θh detected by the steering angle sensor 21s, and calculates the pure steering torque Th only based on the operation of the steering wheel 20 by the driver.

$$Th = Ts + Ih ( \frac{{d}^{ 2} θ h}{{dt}^{ 2}} ) + Ch ( \frac{d θ h}{dt} ) \qquad ( 3 )$$

Next, the CPU progresses to step S04, and functions as the target turning angle set part 51. Namely, the CPU sets (calculates) the correct target turning angle θtgt based on the orientation and magnitude of the pure steering torque Th calculated by the pure steering torque calculation part 54. A method for calculating the target turning angle θtgt based on the pure steering torque Th can be properly chosen among various methods well-known to a person skilled in the art.

In the first device 10, a technique, in which the target turning angle θtgt is changed in proportion to a change (ΔTh) in the pure steering torque Th in a fixed time period, is adopted. Specifically, this time value of the target turning angle θtgt can be expressed by the following Formula (4), in which θtgt[n] is a present value of the target turning angle θtgt, θtgt[n−1] is a previous value of the target turning angle θtgt and Kdth is a proportional gain.

θtgt[t]=θtgt[n−1]+Kdth·ΔTh (4)

As an initial value of the target turning angle θtgt, the turning angle θc mechanically specified according to the configuration (for example, gear ratio etc.) of the steering mechanism from the steering angle θh when steering the steering wheel for the first time in each trip of a vehicle carrying the first device can be used, for example.

Next, the CPU progresses to step S05, and sets (calculates) the target assist torque Ta* based on the correct target turning angle θtgt calculated (set) as mentioned above and the turning angle θc at the present time. Namely, the CPU functions as the target assist torque set part 52, and sets (calculates) the target assist torque Ta* for bringing the turning angle θc detected by the turning angle sensor 31 close to the above-mentioned target turning angle θtgt.

A method for calculating (setting) the target assist torque Ta* based on the target turning angle θtgt and the turning angle θc can be chosen among various methods well-known to a person skilled in the art, such as feedback control, in which an error of the turning angle is made smaller, for example. In the first device 10, PI control is adopted, and the target assist torque Ta* is calculated by the following Formulas (5) and (6). In these Formulas, e is an error of the turning angle (difference between the turning angle θc at the present time and the target turning angle θtgt), Ktp is a proportional gain and Kti is an integral gain.

e=θtgt[n]−θc (5)

Ta*=Ktₚe+Ktᵢ∫edt (6)

Next, the CPU progresses to step S06, and functions as the drive control part 53. Namely, the CPU calculates the assist command value Itgt corresponding to the target assist torque Ta* set by the target assist torque set part 52, and controls the assist motor 30 based on the assist command value Itgt to bring the assist torque Ta generated by the assist motor 30 close to the target assist torque Ta*.

A method for calculating the assist command value Itgt corresponding to the target assist torque Ta* can be properly chosen among various methods well-known to a person skilled in the art. In the first device 10, an electric current command value for making the assist motor 30 output the target assist torque Ta* is adopted as the assist command value Itgt.

Specifically, a correspondence relation between the target assist torque Ta* and the assist command value Itgt has been previously determined by a pre-experiment, in which output torque of the assist motor 30 at various electric current command values are measured, etc. Then, a map (lookup table) showing the correspondence relation has been stored in the memory (ROM) of the control part 50, and the assist command value Itgt corresponding to the target assist torque Ta* is identified by making the CPU refer to the map. Thereafter, the CPU progresses to step S07, and drives the assist motor 30 based on the assist command value Itgt identified as mentioned above.

In the above-mentioned Step S05, the target assist torque Ta* is set (calculated) based on the target turning angle θtgt and the turning angle θc, and the assist command value Itgt corresponding to this target assist torque Ta* is set (calculated). However, the assist command value Itgt may be directly calculated based on the target turning angle θtgt and the turning angle θc (without calculating the target assist torque Ta*). In this case, the CPU which functions as the target assist torque set part 52 can directly calculate the assist command value Itgt by the following Formula (7), for example. In the Formula (7), Kp is a proportional gain and Ki is an integral gain.

Itgt=Kₚe+Kᵢ∫edt (7)

Although the embodiments and modifications having specific configurations have been explained above for the purpose of explaining the present invention, it should not be interpreted that the scope of the present invention is limited to these exemplary embodiments and modifications, and it is needless to say that any correction can be properly added within a range of the matters described in the claims and the specification.

### REFERENCE SIGNS LIST

10: Electric power steering device (First device), 20: Steering wheel, 21: Torque sensor, 21s: Steering angle sensor, 22: Intermediate shaft, 30: Assist motor, 31: Turning angle sensor, 40: Steering mechanism, 41: Rack shaft, 42L and 42R: Tie rod, 44L and 44R: Turning wheel, 50: Control part (ECU), 51: Target turning angle set part, 52: Target assist torque set part, 53: Drive control part, and 54: Pure steering torque calculation part.

1. An electric power steering device comprising:
a steering mechanism configured to change a turning angle of turning wheels by transmitting steering torque based on an operation of a steering wheel by a driver and assist torque that is torque generated by an assist motor to a rack shaft,
a torque sensor configured to detect detection steering torque that is a detection value corresponding to said steering torque,
a steering angle sensor configured to detect said turning angle of said turning wheels,
a target turning angle set part configured to set a target turning angle that is a target value of said turning angle of said turning wheels,
a target assist torque set part configured to set target assist torque for bringing said turning angle close to said target turning angle, and
a drive control part configured to control said assist motor based on an assist command value corresponding to said target assist torque and bring said assist torque close to said target assist torque, wherein;
said electric power steering device further comprises:
a steering angle sensor configured to detect a steering angle that is a rotation angle of said steering wheel, and
a pure steering torque calculation part configured to calculate pure steering torque only based on an operation of said steering wheel by said driver by correcting said detection steering torque based on said steering angle, and
said target turning angle set part is configured to set said target turning angle based on orientation and magnitude of said pure steering torque.
